(19) United States
(12) Patent Application Publication
(10) Pub. No.: US 2026/0189516 A1
(43) Pub. Date: Jul. 2, 2026

(54) IN-BAND AND OUT-OF-BAND (IB/OOB) TRAFFIC MANAGEMENT FOR EFFICIENT CROSSBAR SYSTEMS

(71) Applicant: MaxLinear, Inc., Carlsbad, CA (US)

(72) Inventors: Curtis Ling, Carlsbad, CA (US); Masoud Koochakzadeh, Carlsbad, CA (US); Sheng Ye, Carlsbad, CA (US); John Andrew Guckenberger, Carlsbad, CA (US); Sridhar Ramesh, Carlsbad, CA (US)

(73) Assignee: MaxLinear, Inc., Carlsbad, CA (US)

(21) Appl. No.: 19/435,417

(22) Filed: Dec. 29, 2025

Related U.S. Application Data
(60) Provisional application No. 63/739,469, filed on Dec. 27, 2024.

(51) Int. Cl. H04L 49/101; H04L 47/2425

(52) U.S. Cl. CPC H04L 49/101; H04L 47/2433

(57) ABSTRACT

A device includes a plurality of digital signal processors (DSPs), analog crossbars in communication with the DSPs, and a switch controller. The switch controller facilitates control signals using in-band signaling within payload traffic or out-of-band signaling over a dedicated management interface. The system supports dynamic traffic prioritization based on real-time metrics, such as latency and traffic load, ensuring efficient resource allocation and seamless operation during congestion or reconfiguration. Redundant crossbars and failover mechanisms enhance fault tolerance, while granular backpressure selectively throttles traffic flows to prevent bottlenecks. Integrated diagnostic tools monitor performance and optimize traffic flow, enabling high-speed and reliable communication.

### RELATED APPLICATION

This application claims the benefit of U.S. Provisional Application No. 63/739,469, filed Dec. 27, 2024, the disclosure of which is incorporated herein by reference in its entirety.

The examples discussed in the present disclosure are related to in-band and out-of-band traffic management for efficient crossbar systems.

### BACKGROUND

Unless otherwise indicated herein, the materials described herein are not prior art to the claims in the present application and are not admitted to be prior art by inclusion in this section.

Datacenters and artificial intelligence (AI) clusters may use Ethernet switches that are packet switched. Using a packet switched Ethernet switch results in delivery that is not reliable, is variable, and has high latency. Fabric switches provide another possibility in datacenters and AI clusters. Fabric switches, unlike Ethernet switches, are equivalent to circuit-switched networks, rather than packet-switched networks.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

In some examples, a system and device includes digital signal processors (DSPs), analog crossbars in communication with the DSPs, and a switch controller. The switch controller facilitates communication of control signals using in-band signaling embedded within payload traffic or out-of-band signaling over dedicated management interfaces. These mechanisms enable dynamic resource allocation, traffic prioritization, and seamless coordination between system components.

In some examples, a method includes connecting DSPs to analog crossbars and facilitating communication using one or more of in-band or out-of-band signaling to manage control signals. In some examples, in-band signaling is used to embed control within payload traffic, while out-of-band signaling provides an independent channel for system management and monitoring. Such approach ensures efficient traffic flow, supports fault tolerance, and maintains high performance in dynamic network environments.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example device used for in-band and out-of-band communication.

FIG. 2 illustrates an example device used for in-band and out-of-band communication.

FIG. 3 illustrates an example timing diagram used for in-band and out-of-band communication.

FIG. 4 illustrates an example process flow of a device used for in-band and out-of-band communication.

FIG. 5 illustrates an example communication system operable for in-band and out-of-band communication.

FIG. 6 illustrates a diagrammatic representation of a machine in the example form of a computing device within which a set of instructions, for causing the machine to perform any one or more of the methods discussed herein, may be executed.

FIG. 7A illustrates an example block diagram of a data center.

FIG. 7B illustrates an example switch device.

FIG. 7C illustrates an example switch device.

FIG. 7D illustrates an example switch device.

### DESCRIPTION

The systems and methods of the examples described below pertain to the field of high-speed network switches and physical media dependent (PMD) devices with crossbar-based architectures. Modern networks often experience fluctuating traffic patterns and congestion, using dynamic and efficient allocation of crossbar resources. Traditional static or fixed-path routing techniques lack the flexibility to respond to real-time network demands, often leading to inefficient bandwidth utilization and increased latency.

Managing in-band and out-of-band traffic may be used to enhance the efficiency of control signaling. There are different techniques for managing in-band and out-of-band communication within devices with respect to traffic control, resource allocation, and system monitoring.

Examples of the described herein will be explained with reference to the accompanying drawings.

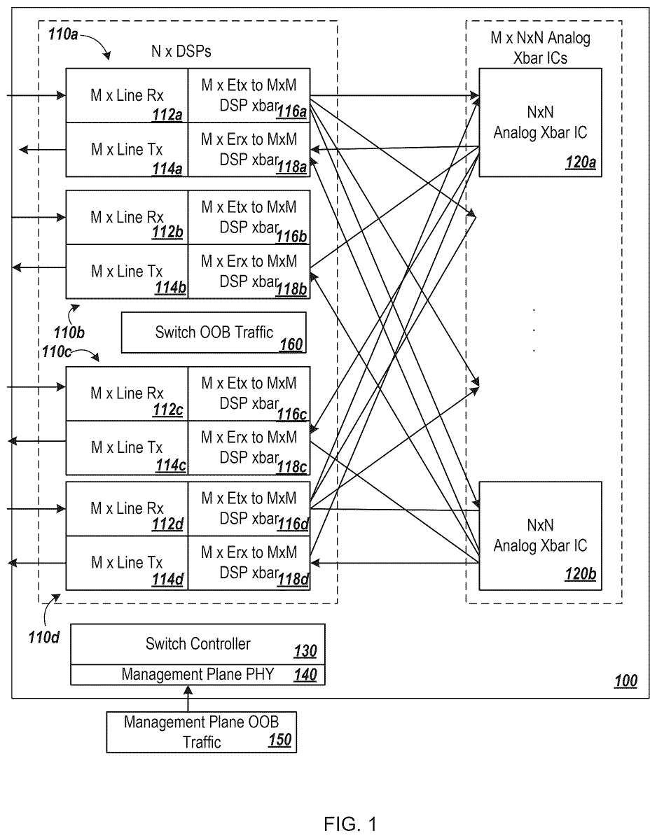

As illustrated in FIG. 1, an analog electrical circuit switch (AECS) system 100 (hereinafter “system 100”) may include one or more digital signal processors (DSPs) 110a, 110b, 110c, 110d. The AECS may include a switch controller 130, a management plane physical layer, and/or management plane out-of-band (OOB) traffic 150. System 100 may include one or more analog crossbar (“xbar”) integrated circuits (IC) (e.g., analog crossbars 120a, 120b). In this example, the switch controller may be a separate component from a DSP 110a, 110b, 110c, 110d. The switch controller 130 may interface with the management plane physical layer 140. The management plane physical layer may communicate with the management plane using management plane OOB traffic 150.

A DSP 110a may include an M×Line Rx 112a, an M×Line Tx 114a, an M×ETx to M×M DSP xbar 116a, and an M×ERx to M×M DSP xbar 118a. A DSP 110b may include an M×Line Rx 112b, an M×Line Tx 114b, an M×ETx to M×M DSP xbar 116b, and an M×ERx to M×M DSP xbar 118b. A DSP 110c may include an M×Line Rx 112c, an M×Line Tx 114c, an M×ETx to M×M DSP xbar 116c, and an M×ERx to M×M DSP xbar 118c. A DSP 110d may include an M×Line Rx 112d, an M×Line Tx 114d, an M×ETx to M×M DSP xbar 116d, and an M×ERx to M×M DSP xbar 118d. A DSP xbar may be a digital crossbar integrated in the DSP.

A PMD device may include a DSP 110a, 110b, 110c, 110d. The PMD may be an electrical-optical module or an electrical-electrical module.

A client may be a system communicating line-side in-band traffic to the AECS 100. For example, a server may be a system communicating line-side in-band traffic to the AECS 100.

Line-side in-band (IB) bandwidth may be line traffic communicated to or from a client. IB switch traffic may be IB traffic directed into or out of or within the AECS 100.

The switch controller (SC) 130 may manage and control AECS 100 devices. In one example, the switch controller 130 may be a microcontroller unit (MCU). Alternatively or in addition, the switch controller 130 may be a DSP.

Switch OOB traffic may be traffic among the SC 130, DSP 110a, 110b, 110c, 110d, analog crossbars 120a, 120b carried on a different network and physical layer than IB; may be carried on analog crossbars 120a, 120b with redundancy.

An “Xbar IC” may be an analog Xbar IC which may be a chip implementing an analog crossbar with input and output lanes.

Management plane OOB traffic may be traffic from outside system 100 via management plane physical layer (PHY) to configure and manage the AECS.

A device (e.g., AECS 100) may include DSPs 110a, 110b, 110c, 110d, analog crossbars 120a, 120b in communication with DSPs 110a, 110b, 110c, 110d, and/or a switch controller 130 that may communicate with DSPs 110a, 110b, 110c, 110d and analog crossbars 120a, 120b using in-band signaling to facilitate control signaling within a payload.

Various kinds of in-band signaling may be handled within the payload. For example, resource allocation and control signaling may be handled within the payload. Alternatively or in addition, crossbar reconfiguration may be facilitated using in-band signaling. Low-latency signaling may be facilitated using layer 2 (L2) or layer 3 (L3) stack including frame processing and/or header processing.

In-band control may be performed by allowing clients to communicate with the device via in-band bandwidth (e.g., an in-band payload) by addressing DSPs 110a, 110b, 110c, 110d and/or the switch controller 130. Packet headers and/or frame headers may be inspected by DSPs 110a, 110b, 110c, 110d for routing within the device, or for being sent to the switch controller 130.

The switch controller 130 may facilitate resource allocation. The switch controller 130 may communicate using OOB signaling to facilitate control signaling within the device. Using OOB signaling for control plane traffic may provide for management tasks that may not impact data flows.

OOB wiring may include a dedicated layer from DSPs 110a, 110b, 110c, 110d to analog crossbars 120a, 120b and/or a microcontroller. The OOB wiring may be compatible with DSPs 110a, 110b, 110c, 110d by using e.g., inter-integrated circuit (I2C) and/or serial peripheral interface (SPI), another OOB input/output mode, or the like. The switch controller 130 may communicate via OOB network interface card (NIC) (e.g., using 10 Gbps Ethernet) to the datacenter.

The control plane may manage the device using a control plane physical layer. The client may signal the device by a separate network connection carrying control plane traffic. Out-of-band signaling within the device may use a separate physical layer and connectivity for communication among DSPs 110a, 110b, 110c, 110d, analog crossbars, 120a, 120b, and/or the switch controller 130. The communication may include one or more of SPI, I2c, OOB input/output, or the like. Out-of-band signaling within the device may be used for control, management, and/or synchronization of the device. Out-of-band signaling may be used for network telemetry.

When using separate wiring for OOB communication, various topologies may be used such as a star topology, a daisy chain topology, a mesh topology, and/or any other topology that may allow for shared use of analog crossbar 120a, 120b redundant capacity. Interconnecting DSPs 110a, 110b, 110c, 110d, analog crossbars 120a, 120b, and the switch controller 130 may maintain the medium access protocol (MAP) cycle, facilitate synchronization, update the device state, and/or update the device tables.

The analog crossbars 120a, 120b (e.g., as an analog crossbar integrated circuit) may have an OOB transceiver. The OOB transceiver may communicate using one or more of SPI, I2C, 10 Gbps serializer/deserializer (SERDES), or the like. The analog crossbars 120a, 120b may be addressable using a protocol. The OOB transceiver may tap one or more of the analog crossbars 120a, 120b inputs and/or outputs. One or more of R redundant inputs may be used.

The device may include a redundant crossbar which may be used to communicate using one or more of IB signaling and/or OOB signaling when failover occurs. The redundant crossbars and/or communication paths for OOB traffic and/or IB traffic may provide for failover and/or fault tolerance in control operations.

Redundancy may allow communication to DSPs 110a, 110b, 110c, 110d without blocking IB signaling. The switch controller 130 may broadcast to DSPs 110a, 110b, 110c, 110d and/or analog crossbars 120a, 120b. The switch controller 130 may use OOB signaling to communicate with individual DSPs 110a, 110b, 110c, 110d and/or analog crossbars 120a, 120b. Time division multiplexing (TDM) and/or broadcast may be used to address a subset of DSPs 110a, 110b, 110c, 110d and/or analog crossbars 120a, 120b.

An OOB transceiver may be integrated in analog crossbars 120a, 120b and may be individually addressable and/or use TDM.

One or more auxiliary IB transceivers may be included in DSPs 110a, 110b, 110c, 110d. The auxiliary IB channel may use the same physical layer as other IB channels. The auxiliary IB may use redundant analog crossbars 120a, 120b to communicate with other devices. The auxiliary IB channel may be used to deliver and/or combine IB traffic e.g., from one or more of DSPs 110a, 110b, 110c, 110d IB lanes. The auxiliary IB channel may communicate with nearest neighbors e.g., using a separate wire to connect nearest neighbor auxiliary IB lanes.

One or more redundant R lanes may be used for OOB signaling. For example, an OOB transceiver within DSPs 110a, 110b, 110c, 110d and/or within the switch controller 130 may be used for OOB signaling. The switch controller 130 may use one or more of R lanes to connect to DSPs 110a, 110b, 110c, 110d. The OOB transceiver may use a lower rate than an IB transceiver (e.g., using I2C, SPI, 10 Gbps SERDES, or the like).

OOB signaling may be used to broadcast from one DSP 110a, 110b, 110c, 110d and/or switch controller 130 to a different DSP 110a, 110b, 110c, 110d.

One or more R lanes may be used to implement hitless switching. The switch controller 130 may route in-band traffic through one or more of R lanes.

The switch controller 130 may prioritize a first source over a second source in which the first source may be one or more of a data signal or a control signal and in which the second source may be one or more of a data signal or a control signal. Different algorithms for prioritizing control signals over data traffic may be used so that management tasks may be handled without delay.

The switch controller 130 may monitor the device using OOB signaling. Analog crossbars 120a, 120b may use OOB signaling and/or IB signaling to communicate to a network controller e.g., using a 10 Gbps lane that may use an available or redundant path.

A device may include DSPs 110a, 110b, 110c, 110d, analog crossbars 120a, 120b, and/or a switch controller that may communicate with DSPs 110a, 110b, 110c, 110d and analog crossbars 120a, 120b using out-of-band signaling. The switch controller 130 may facilitate resource allocation. The switch controller 130 may communicate using OOB signaling to facilitate control signaling within the device. The device may include a redundant crossbar that may communicate using one or more of IB signaling or OOB signaling when failover occurs. The switch controller 130 may prioritize a first source over a second source. The first source may be one or more of a data signal or a control signal. The second source may be one or more of a data signal or a control signal. The switch controller 130 may monitor the device using e.g., out-of-band signaling.

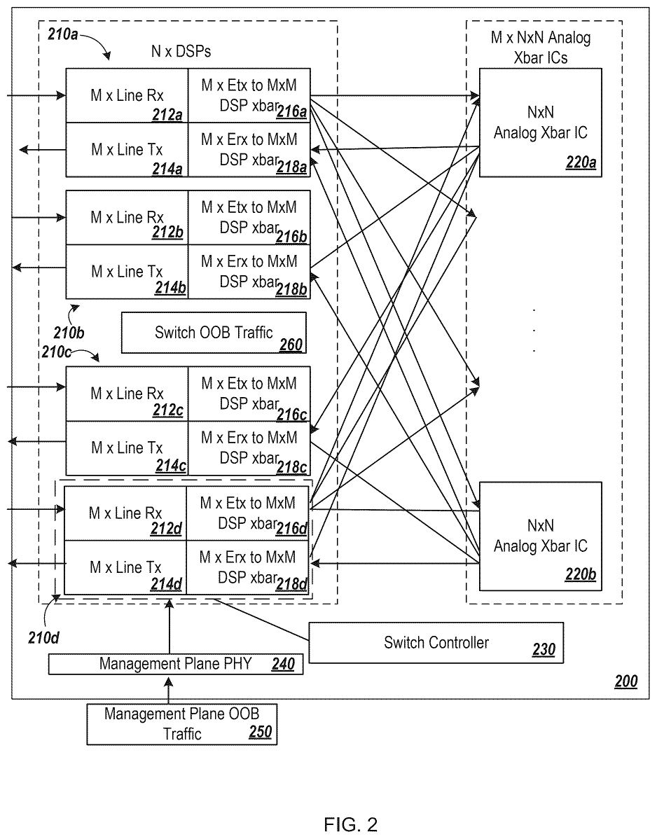

As illustrated in FIG. 2, for AECS 200, a DSP 210a may include an M×Line Rx 212a, an M×Line Tx 214a, an M×ETx to M×M DSP xbar 216a, and an M×ERx to M×M DSP xbar 218a. A DSP 210b may include an M×Line Rx 212b, an M×Line Tx 214b, an M×ETx to M×M DSP xbar 216b, and an M×ERx to M×M DSP xbar 218b. A DSP 210c may include an M×Line Rx 212c, an M×Line Tx 214c, an M×ETx to M×M DSP xbar 216c, and an M×ERx to M×M DSP xbar 218c. A DSP 210d may include an M×Line Rx 212d, an M×Line Tx 214d, an M×ETx to M×M DSP xbar 216d, and an M×ERx to M×M DSP xbar 218d.

DSPs 210a, 210b, 210c, 210d may use high density digital processes that may integrate switch controller 230 functionality. Thus, the switch controller 230 may have its functionality provided by DSPs 210a, 210b, 210c, 210d. DSPs 210a, 210b, 210c, 210d may facilitate control signaling. Another DSP may be designated as a backup for the DSP that functions as a switch controller 230.

The switch controller 230 (e.g., as provided by a DSP) may communicate with a management plane 240 using a separate physical layer for management plane OOB traffic 250. Crossbars may be configured by a management plane 240 which runs inside or outside the AECS (e.g. via a switch controller). This may allow DSPs 210a, 210b, 210c, 210d and switches to settle and/or reacquire either with a fixed time, by polling DSPs 210a, 210b, 210c, 210d and analog crossbars 220a, 220b, or by interrupts/communications from DSPs 210a, 210b, 210c, 210d and analog crossbars 220a, 220b.

The separate physical layer may be integrated in DSPs 210a, 210b, 210c, 210d or within a separate integrated circuit. The management plane physical layer 240 may be connected to a separate switch to provide for redundancy and/or failover. An additional switch controller 230 may be provided to facilitate redundancy and/or failover.

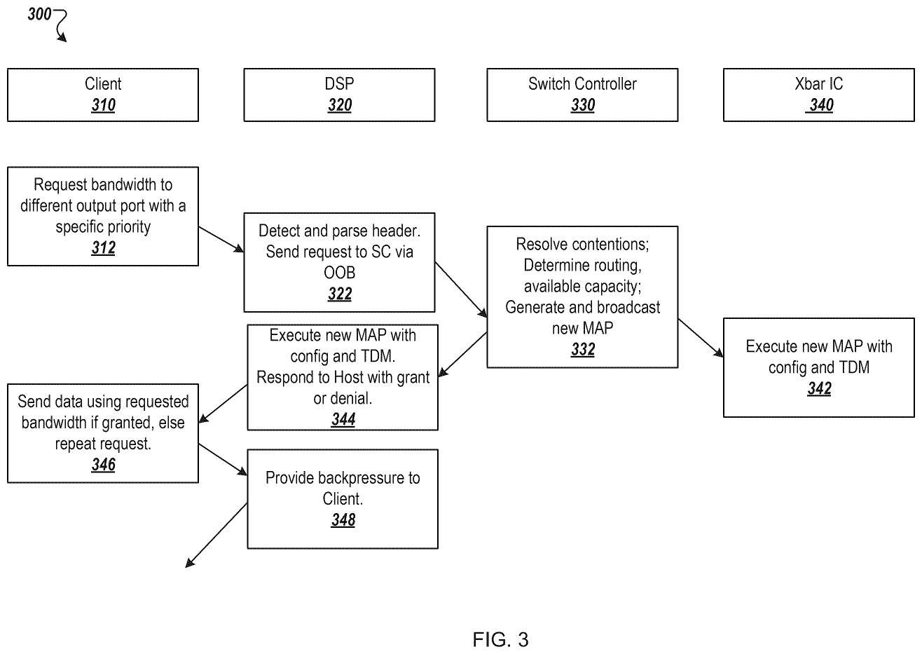

As illustrated in FIG. 3, a timing diagram 300 showing communication between a client 310, a DSP 320, a switch controller 330, and a crossbar IC 340 (i.e., including analog crossbars) is illustrated. The client 310 may communicate with DSP 320 by requesting bandwidth to a different output port with a specific priority, as in block 312. DSP 320 may detect and parse the header and send a request to the switch controller 330 via out-of-band communication, as in block 322. Switch controller 330 may resolve contentions, determine routing and available capacity, and generate and broadcast new MAP, as in block 332. Crossbar IC 340 may execute the new MAP with configuration and TDM, as in block 342. DSP 320 may execute new MAP with configuration and TDM, and respond to the host with grant or denial, as in block 344. The client 310 may send data using requested bandwidth if granted, or else repeat the request, as in block 346. DSP 320 may provide backpressure to client 310, as in block 348, which is discussed in detail below.

In some examples, system 100 implements granular backpressure mechanisms to manage traffic flow with precision. As illustrated in FIG. 1, DSPs 110a-110d receive backpressure signals from downstream components, such as crossbars 120a-120b, when congestion is detected. Rather than halting all traffic flows, backpressure signals target specific traffic streams, ensuring that operations continue unaffected. For example, the switch controller 130 identifies which data flows are contributing to congestion and sends selective throttling instructions to the corresponding DSPs.

As shown in FIG. 2, backpressure signals include metadata derived from traffic headers, such as source and destination addresses, priority levels, and packet types. This metadata enables the DSPs to selectively throttle traffic flows. For instance, if a specific queue carrying low-priority bulk data is causing congestion, that queue is throttled, while high-priority queues continue transmitting. This approach ensures that latency-sensitive traffic, such as real-time audio or video, remains uninterrupted.

In some examples, crossbars 220a-220b, as illustrated in FIG. 3, implement selective flow control by monitoring the occupancy levels of individual output lanes. When a specific output lane becomes congested, the crossbar sends backpressure signals to the upstream DSP responsible for the corresponding input queue. The DSP then adjusts the data rate for that specific flow, preventing further congestion without impacting other lanes.

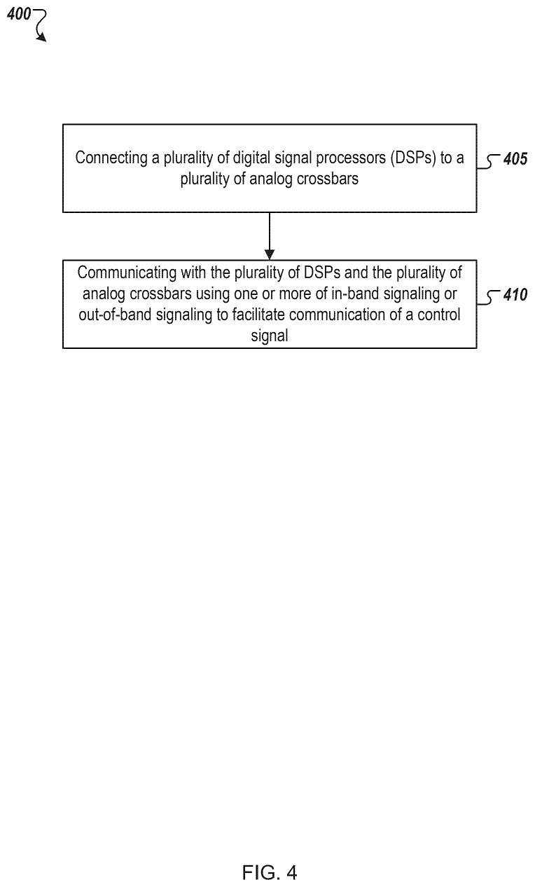

The switch controller 130 dynamically adjusts backpressure thresholds based on real-time metrics, such as queue occupancy levels, link utilization, packet loss rates. As shown in FIG. 4, thresholds are lowered during peak traffic periods to detect and mitigate congestion early, while higher thresholds are used during low traffic to maximize throughput. This adaptive approach ensures that backpressure mechanisms are neither too aggressive nor too lenient, maintaining system stability and efficiency.

In some examples, the switch controller implements granular rate-limiting techniques to complement backpressure signaling. For example, if a specific traffic flow exceeds its allocated bandwidth, the controller applies rate limiting to that flow. As illustrated in FIG. 3, rate limits are enforced using TDM cycles, ensuring that affected flows are slowed down without disrupting other traffic.

When backpressure signals indicate persistent congestion in a specific path, the switch controller 130 reroutes affected traffic to alternate crossbars or lanes, as shown in FIG. 4. This flow-specific rerouting ensures that congestion does not escalate while maintaining overall system throughput. For example, traffic destined for a congested output lane in crossbar 120a is dynamically redirected to an alternate path through crossbar 120b.

In some examples, backpressure mechanisms operate across multiple layers of the system. For instance, the DSPs 110a-110d handle local flow control by throttling specific queues, while the switch controller coordinates global traffic adjustments. As illustrated in FIG. 2, this hierarchical approach ensures that backpressure signals are processed efficiently at local and global levels.

In some examples, system 100 includes diagnostic tools to monitor and visualize backpressure events in real time. As shown in FIG. 3, the switch controller logs backpressure signals, including their source, target, and associated metadata. This information is used to identify recurring congestion patterns and refine traffic management policies. For example, if a specific queue triggers backpressure, its priority level or allocated bandwidth can be adjusted to prevent future bottlenecks.

Such granular backpressure mechanisms provide precise control over traffic flows, ensuring that congestion is mitigated without disrupting high-priority or latency-sensitive operations. By leveraging metadata, adaptive thresholds, and hierarchical coordination, the AECS system achieves efficient and reliable traffic management in dynamic and complex network environments.

Other metrics may be reported to mitigate traffic congestion including e.g., telemetric information such as time stamp, port identifier, switch identifier, flow identifier, sender identifier, total transmitted bytes, egress rate, status bits, trend direction, queue depth, queue occupancy, or the like.

In addition or alternatively, the AECS may be an optical circuit switch (OCS). Any technique suitable for an AECS may be applied to an OCS.

FIG. 4 illustrates a process flow of an example method 400 for in-band and out-of-band communication, in accordance with at least one example described in the present disclosure. The method 400 may be arranged in accordance with at least one example described in the present disclosure.

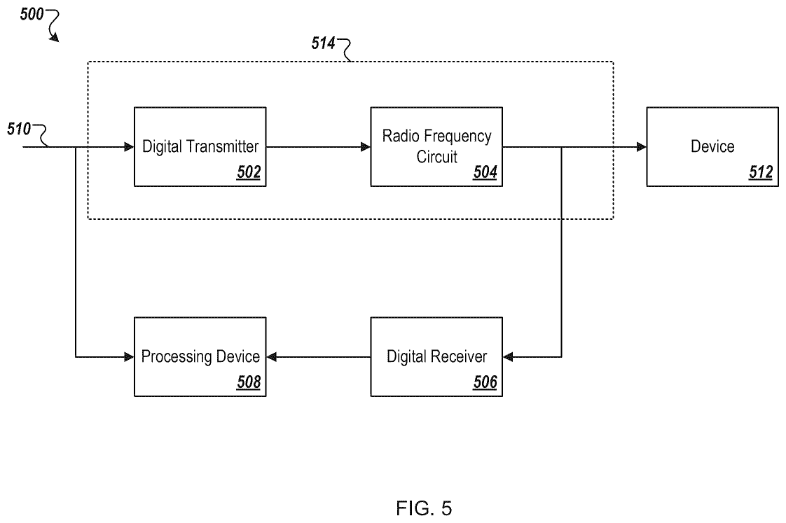

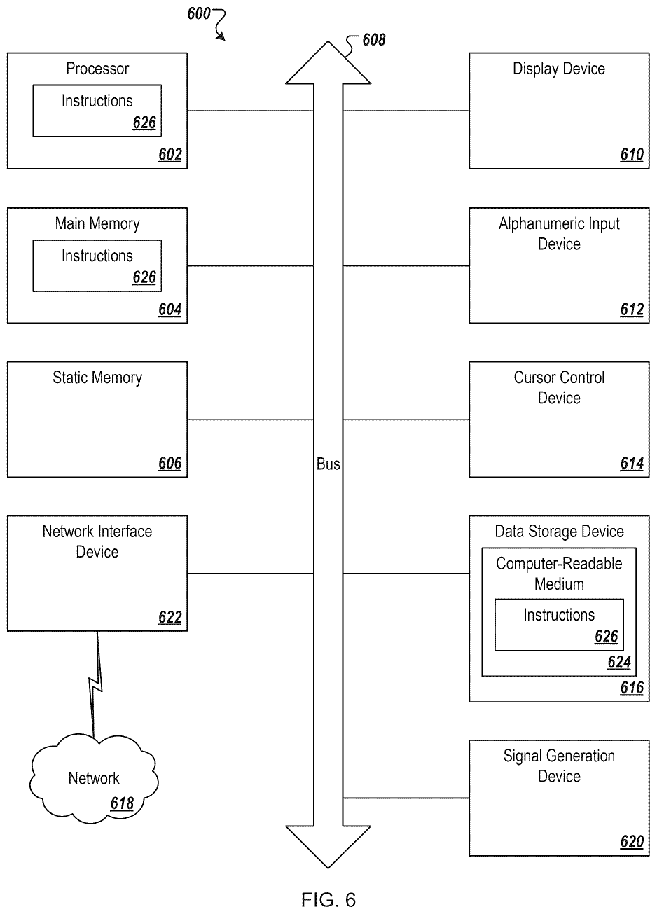

The method 400 may be performed by processing logic that may include hardware (circuitry, dedicated logic, etc.), software (such as is run on a computer system or a dedicated machine), or a combination of both, which processing logic may be included in the processing device 602 of FIG. 6, the communication system 500 of FIG. 5, or another device, combination of devices, or systems.

The method 400 may begin at block 405 where the processing logic may connect DSPs to analog crossbars. At block 410, the processing logic may communicate with DSPs and analog crossbars using one or more of in-band signaling or out-of-band signaling to facilitate communication of a control signal.

### Dynamic Traffic Prioritization Algorithms

In some examples, the switch controller 130 dynamically assigns priority levels to traffic flows based on real-time metrics such as traffic load, latency, and system health. As illustrated in FIG. 1, traffic flows entering the DSPs 110a-110d are tagged with priority metadata derived from application-level or pre-defined system policies. This metadata is used by the switch controller to allocate resources and manage bandwidth effectively.

Telemetric information may also be reported such as time stamp, port identifier, switch identifier, flow identifier, sender identifier, total transmitted bytes, egress rate, status bits, trend direction, queue depth, queue occupancy, or the like.

As shown in FIG. 2, weighted round-robin (WRR) scheduling is implemented within DSPs 210a-210d and crossbars 220a-220b to handle traffic with differing priority levels. WRR ensures that each traffic flow receives a fair share of bandwidth based on its assigned weight. For example, real-time video data may be assigned a higher weight to guarantee low-latency transmission, while bulk data transfers, such as file backups, receive a lower weight. This technique minimizes packet delays for latency-sensitive traffic while maintaining fairness across flows.

In some examples, deficit weighted round-robin (DWRR) scheduling is used to handle traffic with varying packet sizes. As illustrated in FIG. 3, DWRR assigns each queue a deficit counter that tracks unused bandwidth from previous scheduling rounds. This allows the system to efficiently manage larger packets without causing starvation for smaller traffic flows. For example, during peak congestion, DWRR ensures that queues with larger packet sizes continue to receive service without monopolizing available bandwidth.

The switch controller 130 dynamically adjusts priority levels during periods of congestion or crossbar reconfiguration, as shown in FIG. 4. For instance, if crossbar 220a experiences a sudden spike in traffic, the controller reassigns priority levels based on real-time traffic conditions. High-priority traffic, such as fault recovery signals, may preempt lower-priority flows, such as routine maintenance traffic, to ensure system operations are unaffected.

In some examples, the system incorporates latency-aware scheduling algorithms to prioritize traffic with strict timing. As shown in FIG. 2, DSPs 210a-210d monitor latency metrics for each queue and adjust scheduling parameters accordingly. For example, traffic with end-to-end latency constraints, such as financial transactions, is prioritized over non-critical data flows to meet strict quality of service (QoS) targets.

The switch controller 130 leverages real-time metrics, such as queue depth, packet loss rates, and link utilization, to dynamically adjust priority levels. For example, during crossbar reconfiguration, the controller uses queue occupancy data to ensure that high-traffic queues receive sufficient bandwidth while maintaining fairness for other flows. In FIG. 3, the timing diagram shows how priority adjustments are coordinated with TDM cycles to minimize disruptions.

In some examples, during crossbar reconfiguration, as shown in FIG. 4, the switch controller implements temporary priority overrides to prevent packet loss. For example, traffic flows routed through reconfigured crossbars are given higher priority to ensure timely delivery. Once the reconfiguration is complete, priority levels are restored to their original state to maintain system balance.

In some examples, the switch controller aggregates multiple low-priority flows into a single weighted queue to optimize resource utilization. As shown in FIG. 3, aggregated queues are assigned a combined priority level that ensures efficient bandwidth allocation without disrupting high-priority traffic. This approach reduces scheduling overhead and improves overall throughput during high-traffic periods.

Such prioritization techniques discussed above are advantageous by ensuring that the system 100 effectively manages competing demands, minimizes latency for operations, and maintains fairness across traffic flows. By dynamically adjusting priority levels based on real-time metrics and network conditions, the system achieves high performance and reliability in diverse and dynamic environments.

The processing logic may communicate with DSPs and analog crossbars using in-band signaling to facilitate control signaling within a payload. The processing logic may facilitate resource allocation. The processing logic may communicate using out-of-band signaling to facilitate control signaling. The processing logic may communicate using one or more of in-band signaling or out-of-band signaling when failover occurs. The processing logic may prioritize a first source over a second source in which the first source may be one or more of a data signal or a control signal and in which the second source may be one or more of a data signal or a control signal. The processing logic may monitor using out-of-band signaling. A switch controller may communicate with DSPs and analog crossbars using one or more of in-band signaling or out-of-band signaling.

Modifications, additions, or omissions may be made to the method 400 without departing from the scope of the present disclosure. For example, in some examples, the method 400 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

In some examples, AECS system 100 incorporates a dedicated management interface corresponding to the switch controller 130 to facilitate control, management, and monitoring tasks independently from in-band data traffic. As illustrated in FIG. 6, this dedicated interface (e.g., interface 622) operates via a separate physical layer, ensuring that control plane operations do not interfere with payload traffic. This design isolates high priority management tasks, such as configuration updates, diagnostics, and fault recovery, from data streams, enhancing system reliability and performance.

Such dedicated interface supports industry-standard protocols, including SPI, I2C, and 10 Gbps Ethernet, to ensure compatibility with diverse hardware and network infrastructures. For example, SPI and I2C provide low-latency communication between the switch controller and DSPs for real-time updates, while Ethernet interfaces facilitate external management tasks, such as connecting to a data center's monitoring systems. This layered approach allows the AECS to integrate seamlessly with existing and emerging network standards.

The dedicated interface enables real-time monitoring and diagnostics of the AECS system. For instance, the switch controller 130 uses the interface to collect metrics such as queue occupancy levels, link utilization, and error rates from DSPs 110a-110d and crossbars 120a-120b. This information is relayed to external monitoring systems for analysis, allowing operators to identify and resolve issues proactively. The interface also supports automated fault detection and reporting, minimizing downtime and maintenance costs.

In some examples, the dedicated interface is equipped with redundant paths to ensure failover capabilities during hardware or network failures. As illustrated in FIG. 3, the switch controller reroutes management traffic through backup interfaces when the primary path is unavailable. For example, if the SPI interface experiences a failure, the system automatically switches to an Ethernet interface to maintain uninterrupted control plane operations.

The dedicated interface integrates seamlessly with OOB signaling channels to enhance system functionality. For example, the OOB transceiver within DSPs 110a-110d uses the interface to communicate management tasks to the switch controller 130. This integration allows for advanced features, such as time-division multiplexing (TDM) for efficient bandwidth allocation and broadcast communication for system-wide updates.

The separate dedicated interface is particularly advantageous in complex network environments, such as data centers and telecommunications systems. For instance, during a crossbar reconfiguration event, the interface ensures that control signals are transmitted without disrupting payload data. Similarly, in a fault recovery scenario, the interface allows operators to isolate and address issues without affecting ongoing traffic flows.

In some examples, the dedicated management interface facilitates real-time fault detection by monitoring system components, such as DSPs 110a-110d, crossbars 120a-120b, and associated communication links. As illustrated in FIG. 4, the switch controller 130 receives status updates from DSPs via the separate interface, including metrics such as signal integrity, queue occupancy, and link status. If an anomaly, such as excessive packet loss or a link failure, is detected, the interface immediately generates an alert and triggers corrective actions.

For example, in the event of a link failure between DSP 210a and crossbar 220a, the dedicated interface relays diagnostic data to the switch controller 130, pinpointing the fault's location and cause. This information is used to isolate the faulty component and reroute traffic to an alternate path, leveraging redundant crossbars or DSPs. The ability to maintain uninterrupted control plane communication during fault recovery minimizes service disruptions and ensures system reliability.

In addition, the interface supports fault isolation and debugging by providing detailed logs of system events leading up to the fault. For example, if a power fluctuation caused intermittent errors in crossbar 120b, the interface records voltage levels, packet error rates, and backpressure signals, allowing operators to identify the root cause and implement corrective measures.

The dedicated interface is integral to dynamic crossbar reconfiguration, as illustrated in FIG. 3. When the system initiates a reconfiguration event, the interface coordinates updates to routing tables, resource allocation policies, and queue states across DSPs and crossbars. For example, if a new traffic flow requires reallocation of bandwidth on crossbar 220b, the switch controller uses the interface to communicate updated routing instructions to DSPs 210a-210d and crossbars 220a-220b.

During reconfiguration, the interface ensures that in-band (IB) traffic is seamlessly rerouted while maintaining synchronization with out-of-band (OOB) control signals. For instance, the switch controller uses the interface to broadcast a new medium access protocol (MAP) cycle to all components, as shown in FIG. 4. This synchronization minimizes packet loss and latency during the transition, ensuring that high-priority traffic remains unaffected.

In scenarios involving multi-step reconfiguration, the interface manages intermediate states to prevent traffic bottlenecks. For example, if a reconfiguration event involves rerouting traffic across multiple crossbars, the interface coordinates the timing of each step to ensure that queues in DSPs 210a-210d remain balanced. The ability to execute such complex reconfiguration processes with minimal disruption highlights the interface's role in maintaining system performance.

In some examples, the dedicated management interface enables comprehensive traffic diagnostics by collecting and analyzing real-time data from DSPs, crossbars, and endpoints. As illustrated in FIG. 2, the interface monitors metrics such as queue depth, link utilization, and error rates, providing a holistic view of system health. These metrics are aggregated by the switch controller and made available to operators through a centralized dashboard.

In some examples, the interface supports advanced diagnostic tools, such as traffic heatmaps and anomaly detection algorithms. For example, during a congestion event, the interface identifies queues with abnormally high occupancy levels and flags them for operator review. This information allows operators to adjust priority levels, reallocate bandwidth, or implement flow control policies to resolve the issue.

The interface also facilitates predictive diagnostics by analyzing historical traffic patterns and identifying potential bottlenecks. For instance, if a specific queue in DSP 210b experiences congestion during peak hours, the interface provides recommendations for proactive adjustments, such as increasing queue depth or reassigning traffic to alternate crossbars.

Diagnostic data collected through the interface is also used for long-term performance optimization. For example, by analyzing trends in error rates and backpressure signals, the switch controller identifies components that may use maintenance or replacement. This proactive approach reduces downtime and enhances system reliability.

For example, in some examples, in multi-tenant data centers, the dedicated interface plays a role in isolating and managing traffic for different clients. For example, during a fault event affecting one tenant's traffic flow, the interface ensures that diagnostics and recovery efforts are localized to that tenant's resources without impacting other tenants. Similarly, reconfiguration events initiated for one tenant's traffic do not disrupt other traffic flows, thanks to the interface's ability to handle granular control signals.

The interface also enables tenant-specific traffic diagnostics, providing operators with real-time insights into each tenant's traffic patterns, resource utilization, and potential bottlenecks. These insights support service-level agreement (SLA) compliance and enhance customer satisfaction.

The dedicated interface ensures secure communication for fault detection, reconfiguration, and diagnostics. For example, control signals transmitted through the interface are encrypted to prevent unauthorized access or tampering. The interface also includes redundant paths to ensure uninterrupted communication during hardware failures or cyberattacks.

In the event of a failure in the primary management interface, such as a disconnected SPI or I2C link, the system automatically switches to a redundant Ethernet-based interface, as illustrated in FIG. 3. This failover mechanism ensures that control plane operations, such as fault recovery or traffic diagnostics, continue without interruption.

FIG. 5 illustrates a block diagram of an example communication system 500 configured for in-band and out-of-band communication, in accordance with at least one example described in the present disclosure. The communication system 500 may include a digital transmitter 502, a radio frequency circuit 504, a device 512, a digital receiver 506, and a processing device 508. The digital transmitter 502 and the processing device may be configured to receive a baseband signal via connection 510. A transceiver 514 may comprise the digital transmitter 502 and the radio frequency circuit 504.

In some examples, the communication system 500 may include a system of devices that may be configured to communicate with one another via a wired or wireline connection. For example, a wired connection in the communication system 500 may include one or more Ethernet cables, one or more fiber-optic cables, and/or other similar wired communication mediums. Alternatively, or additionally, the communication system 500 may include a system of devices that may be configured to communicate via one or more wireless connections. For example, the communication system 500 may include one or more devices configured to transmit and/or receive radio waves, microwaves, ultrasonic waves, optical waves, electromagnetic induction, and/or similar wireless communications. Alternatively, or additionally, the communication system 500 may include combinations of wireless and/or wired connections. In these and other examples, the communication system 500 may include one or more devices that may be configured to obtain a baseband signal, perform one or more operations to the baseband signal to generate a modified baseband signal, and transmit the modified baseband signal, such as to one or more loads.

In some examples, the communication system 500 may include one or more communication channels that may communicatively couple systems and/or devices included in the communication system 500. For example, the transceiver 514 may be communicatively coupled to the device 512.

In some examples, the transceiver 514 may be configured to obtain a baseband signal. For example, as described herein, the transceiver 514 may be configured to generate a baseband signal and/or receive a baseband signal from another device. In some examples, the transceiver 514 may be configured to transmit the baseband signal. For example, upon obtaining the baseband signal, the transceiver 514 may be configured to transmit the baseband signal to a separate device, such as the device 512. Alternatively, or additionally, the transceiver 514 may be configured to modify, condition, and/or transform the baseband signal in advance of transmitting the baseband signal. For example, the transceiver 514 may include a quadrature up-converter and/or a digital to analog converter (DAC) that may be configured to modify the baseband signal. Alternatively, or additionally, the transceiver 514 may include a direct radio frequency (RF) sampling converter that may be configured to modify the baseband signal.

In some examples, the digital transmitter 502 may be configured to obtain a baseband signal via connection 510. In some examples, the digital transmitter 502 may be configured to up-convert the baseband signal. For example, the digital transmitter 502 may include a quadrature up-converter to apply to the baseband signal. In some examples, the digital transmitter 502 may include an integrated DAC. The DAC may convert the baseband signal to an analog signal, or a continuous time signal. In some examples, the DAC architecture may include a direct RF sampling DAC. In some examples, the DAC may be a separate element from the digital transmitter 502.

In some examples, the transceiver 514 may include one or more subcomponents that may be used in preparing the baseband signal and/or transmitting the baseband signal. For example, the transceiver 514 may include an RF front end (e.g., in a wireless environment) which may include a power amplifier (PA), a digital transmitter (e.g., 502), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet MAC/personal communications service (PCS), a resource controller/scheduler, and the like. In some examples, a radio (e.g., a radio frequency circuit 504) of the transceiver 514 may be synchronized with the resource controller via the S-plane device, which may contribute to high-accuracy timing with respect to a reference clock.

In some examples, the transceiver 514 may be configured to obtain the baseband signal for transmission. For example, the transceiver 514 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 514 may be configured to generate a baseband signal for transmission. In these and other examples, the transceiver 514 may be configured to transmit the baseband signal to another device, such as the device 512.

In some examples, the device 512 may be configured to receive a transmission from the transceiver 514. For example, the transceiver 514 may be configured to transmit a baseband signal to the device 512.

In some examples, the radio frequency circuit 504 may be configured to transmit the digital signal received from the digital transmitter 502. In some examples, the radio frequency circuit 504 may be configured to transmit the digital signal to the device 512 and/or the digital receiver 506. In some examples, the digital receiver 506 may be configured to receive a digital signal from the RF circuit and/or send a digital signal to the processing device 508.

In some examples, the processing device 508 may be a standalone device or system, as illustrated. Alternatively, or additionally, the processing device 508 may be a component of another device and/or system. For example, in some examples, the processing device 508 may be included in the transceiver 514. In instances in which the processing device 508 is a standalone device or system, the processing device 508 may be configured to communicate with additional devices and/or systems remote from the processing device 508, such as the transceiver 514 and/or the device 512. For example, the processing device 508 may be configured to send and/or receive transmissions from the transceiver 514 and/or the device 512. In some examples, the processing device 508 may be combined with other elements of the communication system 500.

FIG. 6 illustrates a diagrammatic representation of a machine in the example form of a computing device 600 within which a set of instructions, for causing the machine to perform any one or more of the methods discussed herein, may be executed. The computing device 600 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 600 includes a processing device (e.g., a processor) 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)) and a data storage device 616, which communicate with each other via a bus 608.

Processing device 602 represents one or more general-purpose processing devices such as a microprocessor, central processing unit, or the like. More particularly, the processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also include one or more special-purpose processing devices such as an application specific integrated circuit (ASIC), a field programmable gate array (FPGA), a DSP, network processor, or the like. The processing device 602 is configured to execute instructions 626 for performing the operations and steps discussed herein.

The computing device 600 may further include a network interface device 622 which may communicate with a network 618. The computing device 600 also may include a display device 610 (e.g., a liquid crystal display (LCD) or a cathode ray tube (CRT)), an alphanumeric input device 612 (e.g., a keyboard), a cursor control device 614 (e.g., a mouse) and a signal generation device 620 (e.g., a speaker). In at least one example, the display device 610, the alphanumeric input device 612, and the cursor control device 614 may be combined into a single component or device (e.g., an LCD touch screen).

The data storage device 616 may include a computer-readable storage medium 624 on which is stored one or more sets of instructions 626 embodying any one or more of the methods or functions described herein. The instructions 626 may also reside, completely or at least partially, within the main memory 604 and/or within the processing device 602 during execution thereof by the computing device 600, the main memory 604 and the processing device 602 also constituting computer-readable media. The instructions may further be transmitted or received over a network 618 via the network interface device 622.

While the computer-readable storage medium 624 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

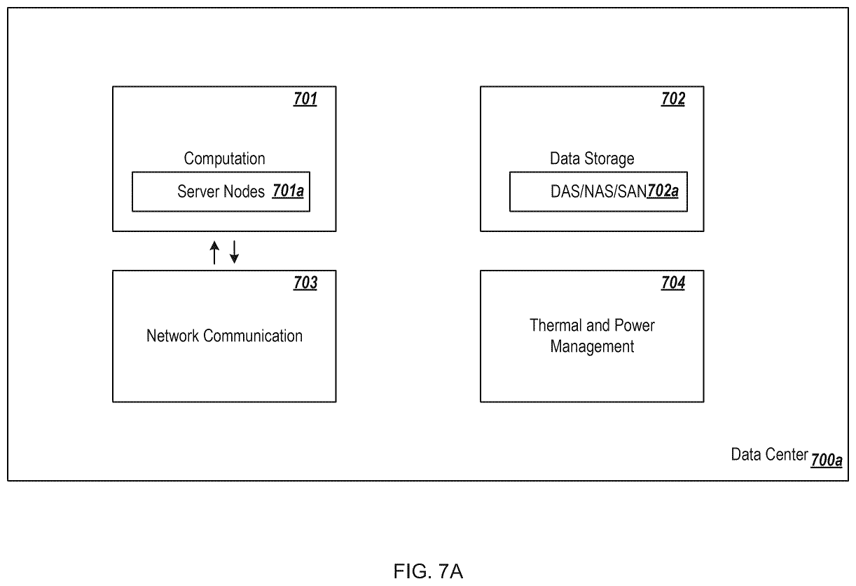

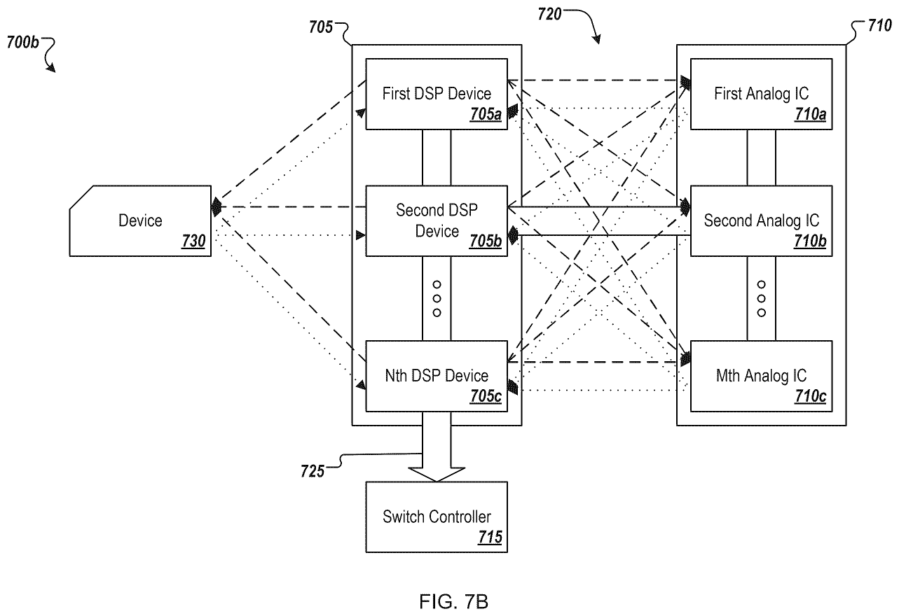

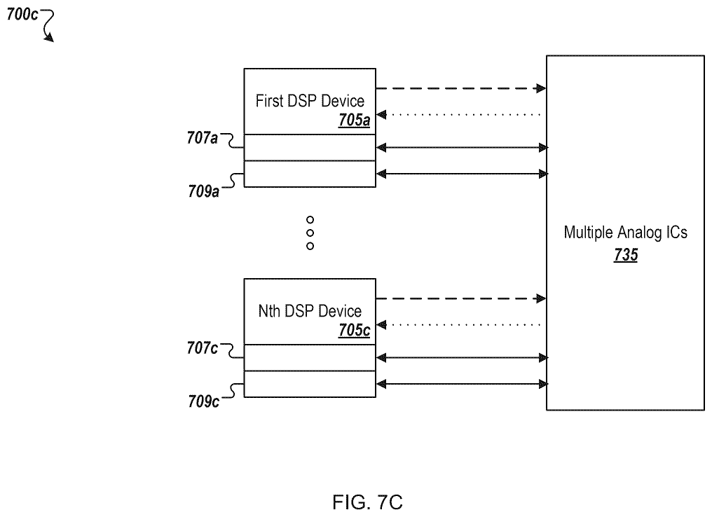

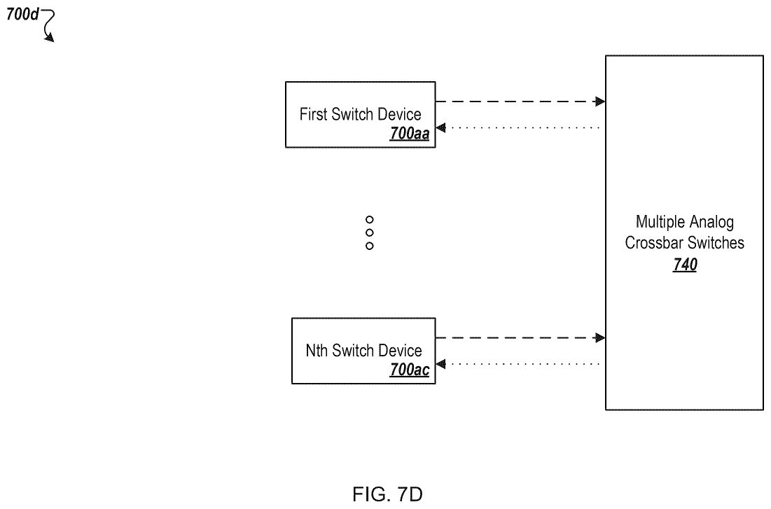

As illustrated in FIG. 7A, a block diagram of a data center 700a may include multiple subsystems configured to perform various operational functions, including computation 701, data storage 702, network communication 703, and thermal and power management 704. The computation 701 subsystem may include one or more server nodes 701a that may execute software applications and process data workloads. The data storage 702 subsystem may provide persistent data retention through devices such as hard disk drives, solid-state drives, or distributed storage arrays, which may be organized in configurations such as Direct Attached Storage (DAS), Network Attached Storage (NAS), or Storage Area Networks (SAN) 702a. The networking communication 703 subsystem may facilitate bidirectional data transfer between servers and external networks through high-speed switching and routing components. The thermal and power management 704 subsystem may maintain operational integrity by regulating temperature and supplying uninterrupted electrical power, e.g., through redundant power sources and cooling mechanisms. Each subsystem may operate in coordination to ensure continuous availability, scalability, and fault tolerance and the ability to scale up and scale out in response to increasing computational and storage demands.

The architecture of a data center 700a may include multiple physical and logical components that collectively enable high-performance computing and data handling. The compute layer may include server racks populated with processors optimized for general-purpose or specialized workloads, including central processing units (CPUs), graphics processing units (GPUs), and field-programmable gate arrays (FPGAs). The storage layer may incorporate hierarchical storage systems that may employ high-speed interfaces such as Non-Volatile Memory Express (NVMe) to reduce latency. The networking layer may use top-of-rack switches, aggregation switches, and core routers arranged in various topologies, (e.g., crossbar, Clos, leaf-spine, etc.) to provide non-blocking connectivity and minimize hop count between endpoints. Power distribution units (PDUs), uninterruptible power supplies (UPS), and backup generators may form the electrical infrastructure, while cooling systems may employ air-based or liquid-based heat dissipation techniques to maintain thermal stability. These components may be integrated to achieve high reliability, modular scalability, and compliance with performance, enabling the system to scale up and scale out as operational loads increase.

In operation, a data center may process client requests through a multi-stage workflow that includes traffic distribution, application execution, and data retrieval. Incoming requests may be received by a load balancing system configured to allocate workloads across multiple compute nodes to prevent resource saturation. Application servers may execute the requested operations, which may involve accessing structured or unstructured data stored within the storage subsystem. Virtualization technologies may enable multiple virtual machines to operate on a single physical server, thereby optimizing resource utilization. Containerization frameworks, such as those implementing Linux containers, may provide isolated execution environments for microservices and facilitate rapid deployment across heterogeneous hardware. The networking subsystem may ensure deterministic packet routing and congestion management through high-speed interconnects and software-defined networking protocols. This operational workflow may be designed to maintain low latency, high throughput, and fault-tolerant performance under variable load conditions, while supporting the ability to scale up and scale out dynamically.

Conventional data center implementations may exhibit several advancements aimed at improving efficiency, scalability, and sustainability. Hyperscale architectures may employ large-scale server clusters interconnected through high-bandwidth fabrics to support cloud computing and artificial intelligence workloads. Edge computing deployments may position micro data centers proximate to end-user devices to reduce network latency and enable real-time processing. Specialized accelerators, including GPUs and tensor processing units (TPUs), may be increasingly integrated to support machine learning and high-performance computing applications. Energy efficiency initiatives may incorporate renewable energy sources and advanced cooling methodologies, such as liquid immersion cooling, to reduce operational costs and environmental impact. These trends reflect an industry-wide transition toward architectures that may be highly distributed, workload-optimized, and environmentally sustainable.

A scale-up network architecture may be characterized by the addition of resources within a single network node or chassis to increase capacity. In such configurations, performance improvements may be achieved by augmenting the processing capability, memory, or port density of an existing switch or router. This approach may involve deploying high-capacity modular switches with vertically integrated backplanes and high-bandwidth switch fabrics. The scale-up model may be advantageous for environments having centralized control and minimal inter-node latency, as traffic may be processed within a single logical device.

A scale-out network architecture may be characterized by the horizontal expansion of network capacity through the addition of multiple interconnected nodes. In this configuration, performance and scalability may be achieved by distributing workloads across multiple switches, for example arranged as a leaf-spine architecture. Each leaf switch may provide connectivity to compute and storage resources, while spine switches interconnect the leaf layer to form a non-blocking, high-bandwidth fabric. The scale-out model may enable incremental capacity expansion without completely replacing existing infrastructure, thereby supporting elastic growth and fault tolerance. This architecture may be particularly suited for large-scale data centers and cloud environments, where traffic patterns may be highly distributed and use predictable bandwidth. Scale-out networks may leverage parallelism and redundancy to achieve near-linear scalability.

A scale-up network may carry information, including AI training and inference algorithms, among computing units (such as graphics processing units (GPUs)). These networks may have various characteristics such as high bandwidth (e.g., non-blocking all-to-all bandwidth), low latency (e.g., minimize layers of switching and per-switch latency), and scalability (e.g., supporting high numbers of interconnected GPUs and low energy per bit transferred through network). For purposes of this disclosure, a “GPU” has been provided as an example and instances of GPU may be substituted by any type of processor such as CPUs, ASICs, or the like.

Conventional scale-up networks may centralize the switching/routing function in order to scale GPU connectivity across multiple rack units and even multiple racks. An example compute rack may include 18 compute trays consuming about 6 kW each, and 9 switch trays consuming about 1 kW each. Each GPU may have 18 ports of 100 GB/s each (or 1.8 TB/s per GPU), and the rack network (which may be implemented using a copper backplane) may connect each GPU to the 9 switch trays to provide each GPU with the ability to deliver its 1.8 TB/s to any other GPU in the rack, a capability often referred to as “All-to-All bandwidth”. This may be used for parallelizing the computation of an AI model for training or inference purposes.

This rack-level power density may be quite high and push the limit of electrical power and thermal cooling densities, leaving little room for additional compute trays. Furthermore, switch connectivity for all-to-all crossbar-like functionality has complexity and power which may vary quadratically with the number of ports being interconnected, so scaling the GPUs connected within a rack may be constrained, even when the number of GPUs may be increased.

A centralized full crossbar may be replaced with distributed crossbars which places ultra-efficient, ultra-low-latency analog crossbars locally with their respective GPUs, and routes them to digital switch system on chips (SOCs) with an arrangement of crossbars which may be simplified compared with full crossbars. This may drive improvements in network power, latency, complexity, and scalability.

As a result, network traffic (e.g., which may be AI traffic) may be matched with low predictable latency providing all-to-all bandwidth. Compared to Ethernet packet switches, ⅕ of the power may be consumed. The device may be capable of high radix implementations (e.g., 1024 lanes). The device may be usable in all-copper backplane scale ups as well as with multi-mode (MM) fiber.

Thus, the examples described herein present systems and methods for an Analog Electrical Circuit Switch (AECS) switch capable of ultra-low-latency (e.g., <5 ns, 10 ns, or the like) and low-power switching across a flexible any-to-any crossbar architecture. The AECS switch eliminates internal buffering and packet inspection within the crossbar, allowing for a highly efficient and scalable architecture. A programmable crossbar configuration may dynamically map input ports to output ports in response to real-time traffic conditions.

An example system may include advanced control mechanisms for broadcasting and multicasting data from a single input to multiple outputs, optimizing resource allocation and minimizing overhead. Make-before-break (MBB) protocols may be employed to ensure seamless reconfiguration of crossbar connections without data loss, even during high-speed operations. Additionally, adaptive equalization techniques may be integrated into the system, allowing the AECS to optimize signal quality based on feedback from connected devices.

An architecture may include redundancies along with digital signal processors (DSPs) configured to support any-to-any connections. In such an arrangement, low-latency switching along with low power use per lane may be achieved. Further, memory included in the DSPs may be used for any storage or buffering and each of the components included in the switch may include redundant lanes such that degradations or broken DSPs may be rerouted around and replaced without losses to the system. The reconfiguration in the switch may be dynamically performed (e.g., such as in view of real-time traffic managed by the switch) by a switch controller that may communicate with the components in the switch using out-of-band traffic so as to not interfere with the in-band communications otherwise being handled by the switch.

FIG. 7B illustrates an example switch device 700b. The switch device 700b may include a first digital signal processor (DSP) device 705a, a second DSP device 705b, an nth DSP device 705c, referred to collectively as multiple first electronic devices 705, a first analog integrated circuit (IC) 710a, a second analog IC 710b, an mth analog IC 710c, referred to collectively as multiple second electronic devices 710, a switch controller 715, in-band traffic 720, and out-of-band traffic 725. First DSP 705a, second DSP 705b, and nth DSP 705c may have input and output as shown in greater detail with respect to FIG. 2.

The switch device 700b may be reconfigurable (e.g., in terms of the connections between the components therein, such as the multiple first electronic devices 705 and the multiple second electronic devices 710, the switch controller 715, and/or a device 730), where the switching of the connections/lanes between the components may be low latency (e.g., less than 5 ns, 10 ns, or the like switching). Alternatively, or additionally, the switch device 700b may reconfigure without the use of retiming such that each lane of the multiple lanes included therein may use less than 50 mW of power. For example, each lane of the multiple lanes may support 100 G bandwidth while using less than 50 mW of power.

The multiple first electronic devices 705 may individually include one or more ports that may be used to facilitate communications within the switch device 700b, such as between the multiple first electronic devices 705 and the multiple second electronic devices 710, the switch controller 715, and/or a device 730. The communications in the switch device 700b may be transmitted via multiple lanes in the switch device 700b. The multiple lanes may facilitate the in-band traffic 720 and/or the out-of-band traffic 725.

The multiple lanes between the multiple first electronic devices 705 and the multiple second electronic devices 710 may be in an any-to-any configuration. For example, the first DSP device 705a may include a lane to the first analog IC 710a, to the second analog IC 710b, and/or the mth analog IC 710c. A similar arrangement may occur for each of the multiple first electronic devices 705, such that each DSP device of the multiple first electronic devices 705 may include a lane to any number of the multiple second electronic devices 710, including none of the multiple second electronic devices 710. As illustrated in FIG. 7, each lane for facilitating the in-band traffic 720 may be in both directions (e.g., transmit and receive) between the multiple first electronic devices 705, the multiple second electronic devices 710, and/or a device 730. Alternatively, or additionally, the lanes are dashed/dotted to illustrate that for any transmit/receive path between the multiple first electronic devices 705, the multiple second electronic devices 710, and/or a device 730, a lane may or may not be present.

The multiple first electronic devices 705, the multiple second electronic devices 710, and/or the switch controller 715 may be disposed on a printed circuit board (PCB) where traces on the PCB may be used to connect at least the multiple first electronic devices 705, the multiple second electronic devices 710, and/or the switch controller 715 (e.g., the traces on the PCB may facilitate the in-band traffic 720 and/or the out-of-band traffic 725 in the switch device 700b). Alternatively, or additionally, the multiple first electronic devices 705, the multiple second electronic devices 710, and/or the switch controller 715 may be connected to one another using connectors, such as high-speed cables, where the multiple first electronic devices 705, the multiple second electronic devices 710, and/or the switch controller 715 may individually include ports/headers to support the use of the connectors. In instances in which the connectors are used, crosstalk between the multiple lanes in the switch device 700b may be reduced relative to the crosstalk that may occur when the switch device 700b uses traces on a PCB.

The switch device 700b, including the multiple first electronic devices 705, the multiple second electronic devices 710, and/or the switch controller 715, may be utilized with one or more additional switches and/or crossbar devices to form a new crossbar switch device, which may be larger than any one of the switch devices 700b. For example, as illustrated and discussed relative to FIG. 7C, the switch device 700b may be utilized with any other number of switch devices 700b (e.g., the nth switch device 700ac in FIG. 7C) and multiple analog crossbar switches 740 to form a new crossbar switch device.

The multiple first electronic devices 705 may be digital signal processors (DSPs) and/or the multiple second electronic devices 710 may be analog circuit switch integrated circuits (ICs) for use with electrical signals. Alternatively, or additionally the multiple second electronic devices 710 may be analog optical circuit switch ICs for use with optical signals. The multiple first electronic devices 705 may be individually configured to support one or more layer of the open systems interconnection (OSI) model. For example, each of the multiple first electronic devices 705 may be configured to support layer 1 protocols, layer 2 protocols, and/or layer 3 protocols with respect to the in-band traffic 720 and/or the out-of-band traffic 725.

Each, or at least one, of the multiple first electronic devices 705 may support layer 1 protocols, which may include detecting and/or processing layer 2 protocols and/or layer 3 protocols, handling layer 2 protocol and/or layer 3 protocol addressability, frame header detection, packet header inspection, responding to layer 2 protocol and/or layer 3 protocol requests, storing information in response to a request associated with layer 2 protocols and/or layer 3 protocols, updating information in response to a request associated with layer 2 protocols and/or layer 3 protocols, communicating information in response to a request associated with layer 2 protocols and/or layer 3 protocols, optimizing information in response to a request associated with layer 2 protocols and/or layer 3 protocols, etc. Each of the multiple first electronic devices 705 may be able to adjust the way in which traffic is directed through it, such as in response to a command from the switch controller 715. For example, each of the multiple first electronic devices 705 may be operable to configure an internal switch, an external switch, or a crossbar based on the various layer protocol processing to be performed.

The first DSP device 705a may receive a communication that includes a frame header (or a packet header) and the first DSP device 705a may be configured to detect the frame header and decode the frame header along with any associated contents of the communication, all within the first DSP device 705a. In a second example, the first DSP device 705a may integrate a media access control (MAC) address lookup table which may allow the first DSP device 705a to configure one or more crossbars such that the first DSP device 705a may facilitate connectivity between any two MAC addresses that are included in the lookup table. Alternatively, or additionally, each of the first electronic devices 705 may include a lookup table that may store equalization settings that may be used for various connections between the first electronic devices 705 and other components within the switch device 700b. The equalization settings in the lookup table may be used to accelerate acquisition and/or tracking for a particular DSP device of the multiple first electronic devices 705 when the particular DSP device switches connections within the switch device 700b.

The multiple first electronic devices 705 may be configured to respond to layer 2 protocol requests and/or layer 3 protocol requests for connectivity and/or resource grant requests. For example, the multiple first electronic devices 705 may compare a request to a lookup table that includes priority levels and the multiple first electronic devices 705 may be operable to configure themselves and/or associated crossbars and/or switches based on the determined priority level. Alternatively, or additionally, each of the multiple first electronic devices 705 may be configured to respond to in-band requests (e.g., granting a connection request, signaling backpressure to the device 730, etc.), collect statistics on traffic handled by the multiple first electronic devices 705 (e.g., link utilization and/or traffic type), and/or perform data filtering (e.g., detecting a particular header, performing routing, generating flags and/or interrupts, and/or logging any of the filtering events).

The multiple first electronic devices 705 may be configured to communicate with (e.g., transmit data to and/or receive data from) the device 730. The communication with the device 730 may include in-band traffic 720. In such instances, the communications between the multiple first electronic devices 705 and the device 730 may be line-side communications, where the lines may facilitate communications using various communication channels. For example, the line-side communications between the multiple first electronic devices 705 and the device 730 may be an electrical-to-electrical connection, an optical-to-optical connection, an electrical-to-optical connection, or an optical-to-electrical connection, and so forth.

The device 730 may address communications directly to one of the multiple first electronic devices 705. For example, the device 730 may address communications to the second DSP device 705b. Alternatively, or additionally, the device 730 may address communications to the switch controller 715, which may then direct communications to the appropriate DSP device. For example, the device 730 may address communications intended for the second DSP device 705b to the switch controller 715 and the switch controller 715 may direct the communications to the second DSP device 705b.

The multiple first electronic devices 705 may individually include memory that may be used as a buffer for communications through the multiple first electronic devices 705. The memory in the multiple first electronic devices 705 may be utilized to buffer incoming and/or outgoing traffic, which may include in-band traffic 720 and/or out-of-band traffic 725. Due to the memory in the multiple first electronic devices 705 being distributed (e.g., by the distributed nature of the multiple first electronic devices 705), the switch device 700b may not include any memory for buffering in addition to the memory included in the multiple first electronic devices 705.

The multiple first electronic devices 705 may individually include one or more additional lanes that may be used for communications in the switch device 700b. Further details associated with the additional lanes are included in the description associated with FIG. 7C.

The multiple second electronic devices 710 may individually include one or more ports that may be used to facilitate communications within the switch device 700b, similar to the ports described relative to the multiple first electronic devices 705. Alternatively, or additionally, the lanes for communications between the multiple first electronic devices 705 and the multiple second electronic devices 710 may be coupled with the ports included in the multiple second electronic devices 710.

The switch controller 715 may be a microcontroller unit (MCU). Alternatively, or additionally, the switch controller 715 may be a DSP, or other processing device. The switch controller 715 may be communicatively coupled with at least the multiple first electronic devices 705 and/or the multiple second electronic devices 710. The switch controller 715 may resolve resource grant requests, distribute the network state to the multiple first electronic devices 705 and/or to the multiple second electronic device 710, and/or may establish and/or maintain timing among the components included in the switch device 700b.

The switch controller 715 may communicate with the multiple first electronic devices 705 and/or the multiple second electronic devices 710 using a separate connection/lane than the connections between the multiple first electronic devices 705 and the multiple second electronic devices 710. For example, the first connection between the multiple first electronic devices 705 and the multiple second electronic devices 710 may facilitate the in-band traffic 720 and the second connection between the switch controller 715 and the multiple first electronic devices 705 and/or the multiple second electronic devices 710 may facilitate the out-of-band traffic 725.

The out-of-band traffic 725 may use a different network than the in-band traffic 720. Alternatively, or additionally, the out-of-band traffic 725 may use a different physical layer protocol than the in-band traffic 720. The out-of-band traffic 725 may be used to manage and/or configure one or more components included in the switch device 700b. For example, the switch controller 715 may communicate with the multiple first electronic devices 705 using the out-of-band traffic 725 to reconfigure lanes and/or traffic routing based on the traffic through the switch device 700b.

The switch controller 715 may be programmable such that the switch controller 715 may be operable to dynamically map the lanes between the multiple first electronic devices 705 and the multiple second electronic devices 710. For example, in instances in which the first DSP device 705a includes a lane to the first analog IC 710a, the switch controller 715 may dynamically map the lane to be from the first DSP device 705a to the second analog IC 710b. The switch controller 715 may dynamically adapt the mapping of the lanes between the multiple first electronic devices 705 and the multiple second electronic devices 710 based on one or more conditions and/or a satisfaction of a threshold related to the conditions. For example, in instances in which the real-time data traffic in the switch device 700b (or an amount of real-time data traffic handled by one of the multiple first electronic devices 705 and/or one of the multiple second electronic devices 710) satisfies a threshold, the switch controller 715 may dynamically adapt the mapping of the lanes as described.

The switch device 700b may include one or more redundant lanes that may be used in various situations during operation of the switch device 700b. For example, one or more redundant lanes may be used for the out-of-band traffic 725, such as signaling using the out-of-band traffic 725. In such instances, the out-of-band signaling may be transmitted and/or received by a particular DSP device and/or by the switch controller 715, and the out-of-band signaling may be a lower transmission rate than the in-band traffic 720. In another example, one or more redundant lanes may be used for out-of-bandwidth broadcasts from the switch controller 715 and/or from one or more of the multiple first electronic devices 705 to other devices in the switch device 700b (e.g., such as other DSP devices).

The switch controller 715 may reserve a portion of bandwidth associated with the in-band traffic 720 in the switch device 700b. The bandwidth reserved by the switch controller 715 may be reserved on a per lane basis of the multiple lanes included in the switch device 700b. For example, a first lane between the first DSP device 705a and the first analog IC 710a may have a first reserved bandwidth and a second lane between the second DSP device 705b and the second analog IC 710b may have a second reserved bandwidth, where the amount of bandwidth reserved may be the same or may differ between the first reserved bandwidth and the second reserved bandwidth. The switch controller 715 may allocate resources within the switch device 700b based on predicted or anticipated traffic (e.g., based on a probabilistic model).

Alternatively, or additionally, the switch controller 715 may monitor the lanes of the multiple lanes in the switch device 700b. The switch controller 715 may monitor the multiple lanes periodically and/or in a round robin manner, such that the lanes of the multiple lanes may observed to determine if failures or degradations may be present in a lane. In instances in which a lane experiences a degradation that satisfies a threshold for an acceptable loss, the switch controller 715 may dynamically remap a new lane in the switch device 700b to replace the degraded lane.

The switch controller 715 may perform adaptive signal equalization to the in-band traffic 720 in the switch device 700b. For example, the multiple first electronic devices 705 may provide feedback to the switch controller 715 relative to the workload handled by the multiple first electronic devices 705, and the switch controller 715 may adaptively manage workloads of the multiple first electronic devices 705 to optimize performance of the switch device 700b.

A backup switch controller (not illustrated) may be included in the switch device 700b. The backup switch controller may be a redundant controller relative to the switch controller 715. The backup switch controller may include the same or similar connections as the switch controller 715 relative to the multiple first electronic devices 705 and/or the multiple second electronic devices 710. The backup switch controller may perform the same or similar operations as the switch controller 715.

FIG. 7C illustrates an example switch device 700c. The switch device 700c may include a first DSP device 705a, an nth DSP device 705c, and multiple analog ICs 735. The first DSP device 705a may include a first auxiliary channel 707a, and a first out-of-band channel 709a. The nth DSP device 705c may include an nth auxiliary channel 707c, and an nth out-of-band channel 709c.

The first DSP device 705a, the nth DSP device 705c, and the multiple analog ICs 735 may be the same or similar as the first DSP device 705a, the nth DSP device 705c, and the multiple second electronic devices 710, respectively, of FIG. 7A and may be operable to perform the same or similar functions as described.

The auxiliary channels 707 (e.g., the first auxiliary channel 707a and the second auxiliary channel 707c) may be individually utilized by each of the DSP devices 705a, 705c as an additional lane for in-band traffic between at least the DSP devices 705a, 705c and the multiple analog ICs 735. The auxiliary channels 707 may be used to redundantly transmit in-band traffic relative to another lane included in the DSP devices 705a, 705c prior to a change in configuration to the corresponding DSP devices 705a, 705c. For example, in instances in which the first DSP device 705a includes a lane to a particular analog IC of the multiple analog ICs 735 and the first DSP device 705a is to be reconfigured (e.g., by a switch controller as described herein), the first auxiliary channel 707a may have a lane mapped to the particular analog IC such that the in-band traffic is redundant between the first DSP device 705a and the particular analog IC prior to reconfiguring the lanes associated with the first DSP device 705a (which reconfiguration may otherwise break the connection between the first DSP device 705a and the particular analog IC).

The auxiliary channels 707 may be used for communication between other near DSP devices. For example, in instances in which the first DSP device 705a is disposed spatially near to the nth DSP device 705c, the first DSP device 705a and the nth DSP device 705c may communicate with one another via the auxiliary channels 707. Such communications may be possible as the channels between near-neighbors may be relatively clean, such that physical layer processing may be simplified and may result in power reduction, latency reduction, a lesser amount of equalization, and/or other benefits to the switch device 700c.

The out-of-band channels 709 may be used to communicate the out-of-band traffic (e.g., the out-of-band traffic 725 of FIG. 7B) on a lane separate from the multiple lanes used to communicate in-band traffic. In such instances, the out-of-band channels 709 may not cause blocking or interference to the in-band traffic between at least the DSP devices 705a, 705c and the multiple analog ICs 735.

FIG. 7D illustrates an example aggregated switch device 700d. The aggregated switch device 700d may include a first switch device 700aa, an nth switch device 700ac, and multiple analog crossbar switches 740. The first switch device 700aa and the nth switch device 700ac may individually be the same or similar as the switch device 700b of FIG. 7B.

The aggregated switch device 700d illustrates that any number of the switch devices 700b (e.g., the first switch device 700aa and the nth switch device 700ac) may be aggregated into another switch device and/or connected to other analog crossbar switches. Each of the switch devices 700b may include multiple DSP devices and multiple analog IC and may be further aggregated into the aggregated switch device 700d using the multiple analog crossbar switches 740. As such, the aggregated switch device 700d may be scaled up or down for any size communication need, by adjusting the switch devices 700b and/or the multiple analog crossbar switches 740 to meet the communication demand.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A device, comprising:
a plurality of digital signal processors (DSPs);
a plurality of analog crossbars in communication with the plurality of DSPs; and
a switch controller operable to communicate with the plurality of DSPs and the plurality of analog crossbars using one or more of in-band signaling or out-of-band signaling to facilitate control signaling and traffic prioritization.

2. The device of claim 1, wherein the switch controller is operable to dynamically assign priority levels to traffic flows based on real-time metrics, including traffic load, latency, or system health.

3. The device of claim 1, wherein the switch controller is operable to facilitate resource allocation using in-band signaling within a payload.

4. The device of claim 1, wherein the switch controller is operable to communicate using out-of-band signaling to facilitate one or more of system management, fault detection, diagnostics, or network telemetry.

5. The device of claim 1, further comprising a redundant crossbar operable to communicate using one or more of in-band signaling or out-of-band signaling when failover occurs.

6. The device of claim 1, wherein the switch controller is operable to prioritize traffic based on algorithms including weighted round-robin (WRR) or deficit weighted round-robin (DWRR).

7. The device of claim 1, wherein the switch controller is operable to monitor traffic flows and provide network telemetry using out-of-band signaling and dynamically adjust one or more of backpressure thresholds or the network telemetry for selective flow control.

8. The device of claim 1, further comprising a dedicated management interface operable to facilitate one or more of system control, reconfiguration, diagnostics, or network telemetry independently of payload traffic.

9. The device of claim 1, wherein the switch controller is operable to reroute traffic dynamically during congestion or crossbar reconfiguration.

10. The device of claim 1, wherein the switch controller integrates real-time diagnostic tools to collect and analyze metrics including one or more of queue depth, link utilization, error rates, time stamp, port identifier, switch identifier, flow identifier, sender identifier, total transmitted bytes, egress rate, status bits, trend direction, queue occupancy for traffic optimization.

11. A method, comprising:
connecting a plurality of digital signal processors (DSPs) to a plurality of analog crossbars; and
communicating with the plurality of DSPs and the plurality of analog crossbars using one or more of in-band signaling or out-of-band signaling to facilitate control signaling and traffic management.

12. The method of claim 11, further comprising dynamically assigning priority levels to traffic flows based on real-time metrics, including traffic load, latency, or queue depth.

13. The method of claim 11, further comprising facilitating resource allocation by communicating control signals within an in-band payload.

14. The method of claim 11, further comprising monitoring system health, monitoring traffic metrics, or providing network telemetry using out-of-band signaling.

15. The method of claim 11, further comprising using a dedicated management interface to facilitate one or more of system reconfiguration, fault detection, diagnostics, or network telemetry independently of data traffic.

16. The method of claim 11, further comprising dynamically adjusting backpressure thresholds to selectively throttle traffic flows based on metadata or traffic headers.

17. The method of claim 11, further comprising using algorithms, including one or more of weighted round-robin (WRR) or deficit weighted round-robin (DWRR), to prioritize traffic flows across the plurality of DSPs and analog crossbars.

18. The method of claim 11, further comprising rerouting traffic dynamically during congestion or crossbar reconfiguration to ensure uninterrupted system performance.

19. The method of claim 11, further comprising facilitating failover by using a redundant crossbar to communicate via one or more of in-band signaling or out-of-band signaling.

20. The method of claim 11, further comprising collecting telemetric information or diagnostic data, including one or more of queue depth, error rates, time stamp, port identifier, switch identifier, flow identifier, sender identifier, total transmitted bytes, egress rate, link utilization, status bits, trend direction, or queue occupancy, and using the telemetric information or the diagnostic data to optimize traffic flow and system resource utilization.
